(19) United States
(12) Patent Application Publication
(10) Pub. No.: US 2006/0119616 A1
(43) Pub. Date: Jun. 8, 2006

(54) System and method for providing 3D image production service

(75) Inventor: Ji-Won Park, Daejeon (KR)

Correspondence Address: JONATHAN Y. KANG, ESQ.;LEE, HONG, DEGERMAN, KANG & SCHMADEKA, P.C., 14th Floor, 801 S. Figueroa Street, Los Angeles, CA, 90017-5554, US

(73) Assignee: NVLSOFT Corporation

(21) Appl. No.: 11/289,220

(22) Filed: Nov. 28, 2005

(30) Foreign Application Priority Data
Dec. 7, 2004 (KR) 10-2004-0102600
Mar. 25, 2005 (KR) 10-2005-0025037

(51) Int. Cl. G09G 5/00

(52) U.S. Cl. 345/619

(57) ABSTRACT

Disclosed herein are a system and method for providing a 3D image production service. The system includes a first DataBase (DB), a user terminal and a service server. The first DB stores information for constructing 3D background screens, web site content information for producing 3D images, and personal information, information about a 3D background screen constructed by a user, and web site information using a 3D image. The user terminal maintains an on-line state through login upon booting, displays a 3D background screen after parsing and rendering 3D data and sets a web site using a 3D image. The service server authenticate a user while maintaining an on-line state with the user terminal, provides the user terminal with relevant tools when the user requests a configuration for managing a web site using the 3D background screen and the 3D image, stores the configuration for managing the web site using the 3D background screen and the 3D image, which is constructed by the user, in a corresponding user storage space of the first DB, and synchronizes information stored in the user terminal with information stored in the first DB.

Pursuant to 35 U.S.C. § 119(a), this application claims the benefit of earlier filing date and right of priority to Korean Patent Application Nos. 10-2004-0102600 and 10-2005-0025037, filed on Dec. 7, 2004 and Mar. 25, 2005, respectively, the contents of which are hereby incorporated by reference herein in their entirety.

### BACKGROUND OF THE INVENTION

1. Field of the Invention

The present invention relates generally to a system and method for providing a 3-demensional image production service and, more particularly, to a system and method for providing a 3-demensional image production service, in which a user terminal accesses a server, constructs its unique 3D background screen and web site, stores the constructed 3D background screen and web site in the server and itself, accesses a network upon booting, and receives various information in real time.

2. Description of the Related Art

In the conventional Windows operating system, a 2-dimensional (2-D) background screen is provided. The 2D background screen does not generate special interest in users.

There are some Internet shopping malls that represent and exhibit articles in three dimensions. A user terminal system for 3D virtual reality implementation and a virtual reality implementation method using the same disclosed in Korean Unexamined Patent Publication No. 2003-54874 provide 3D virtual reality to a user terminal using the user terminal system, which includes an applet for receiving and transmitting X3D data through communication with a service server, a communication module for providing communication between the service server and the user terminal while connecting to the applet, and a browsing means for constructing a scene graph by parsing the X3D data received through the communication module, rendering the scene graph in a predetermined format, and then displaying the rendered graph on the display window of the user terminal.

However, such prior art technologies have limitations in that 3D virtual space cannot be provided to a Windows background screen and a variety of services cannot be provided.

Furthermore, web sites are operated by operators, who have various purposes, such as commercial purposes and public interest purposes, so as to provide services suitable for the purposes through the Internet. In the meantime, recently, a service for enabling individual users to have such web sites has been popularized.

That is, individual users have their own web sites in such a way as to prepare bulletins to inform the public about them and post bulletins on the Web. Although a service for connecting between individual web sites and related services have been provided, a service for providing 3D images has not been provided.

Existing user web site service provides services, such as a background music service and a background picture service, but do not satisfy users' various demands for services. Recent Internet users want to receive services in 3D image form, so that research into a method of providing 3D images to users through a variety of methods is required. In particular, the need for a method of allowing users to produce 3D images reflecting their personalities and to post the produced 3D images on their web sites has increased recently.

In general, it is possible for users to produce 3D images using 3D image authoring software and post the produced 3D images on their web sites. However, it is difficult to require that all users use such 3D image authoring software because the software is expensive and is complicated to use. Furthermore, from the standpoint of service servers that provide web posting, a method of collectively managing the production of 3D images is required because the formats and sizes of 3D images are considerably different from each other and the sizes of data must be standardized, etc., thus requiring standardization.

### SUMMARY OF THE INVENTION

Accordingly, the present invention has been made keeping in mind the above problems occurring in the prior art, and an object of the present invention is to provide a system for providing a 3D image production service, which is capable of providing 3D virtual space to the conventional Windows background screen of a user terminal and allowing the user terminal to access a network upon booting and receive information in real time.

Another object of the present invention is to provide a method of managing background screens and/or web sites using a 3D image production service in which web site users can produce 3D images reflecting their tastes and post them on their background screens and/or web sites.

Further another object of the present invention is to provide a method of managing background screens and/or web sites using a 3D image production service in which a web site provider enables users to post information having a uniform format.

In order to accomplish the above object, the present invention provides a system for providing a 3D image production service, including a first DB for storing information for constructing 3D background screens, web site content information for producing 3D images, and personal information, information about a 3D background screen constructed by a user and web site information using a 3D image, the personal information, the information about a background screen and the web side information being assigned a storage space on a user basis; a user terminal for maintaining an on-line state through login upon booting, displaying a 3D background screen after parsing and rendering 3D data stored in a second DB thereof, and setting a web site using a 3D image; and a service server for authenticating a user while maintaining an on-line state with the user terminal, providing the user terminal with relevant tools when the user requests a configuration for managing a web site using the 3D background screen and the 3D image, storing the configuration for managing the web site using the 3D background screen and the 3D image, which is constructed by the user, in a corresponding user storage space of the first DB, and synchronizing information stored in the user terminal with information stored in the first DB through communication with the user terminal.

Additionally, the present invention provides a method of providing a 3D image production service, including the steps of a first step of a service server, which manages a web site that provides a 3D background screen and a 3D image, providing a user terminal application for producing an 3D image to a predetermined user terminal, a specific background screen or specific web site of which are managed by the service server, and causing the user terminal to install the user terminal application; a second step of the user terminal producing a 3D image using a 3D image concept, a 3D image scenario and a 3D image set, which are provided through the user terminal application, and transferring the produced 3D image to the service server; and a third step of the service server storing the 3D image received from the predetermined user terminal and posting the stored 3D image on a specific web site.

Additionally, the present invention provides a method of providing a 3D image production service, including a first step of a user terminal, which subscribes to the 3D image production service and has a user terminal application for a 3D image service, running the user terminal application; a second step of the user terminal receiving 3D image concepts from a 3D image service server and selecting a desired 3D image concept from among the received 3D image concepts, as the user terminal application is run; a third step of the user terminal receiving 3D image scenarios from the 3D image service server that has received the selected 3D image concept, and selecting a desired scenario from among the received 3D image scenarios; a fourth step of the user terminal receiving a 3D image set from the 3D image service server that has received the selected 3D image scenario, and setting the 3D image set; and a fifth step of the user terminal photographing a 3D image in the set 3D image set and transmitting the photographed 3D image to the 3D image service server so that the photographed 3D image is posted on a web site.

Additionally, the present invention provides a method of providing a 3D image production service, including a first step of a service server, which provides a user terminal with a user terminal application for a 3D image service and provides the 3D image service to the user terminal, detecting running of the user terminal application of the predetermined user terminal and providing 3D image concepts to the predetermined user terminal; a second step of the service server receiving information about selection of a 3D image concept from among the provided 3D image concepts and providing 3D image scenarios based on a selection result; a third step of the service server receiving information about selection of a 3D image scenario from among the provided 3D image scenarios and transmitting a 3D image set based on a selection result; and a fourth step of the service server receiving a 3D image, which is photographed in the 3D image set by the predetermined user terminal, and posting the 3D image on a web site of the user terminal.

Additionally, the present invention provides a method of providing a 3D image production service, including a first step of a service server, which manages a web site, providing a user terminal application for producing a 3D image to a user terminal, a specific web site of which is managed, through the service server; a second step of the user terminal producing a 3D image using DBs regarding characters, backgrounds and small items, which are provided through the user terminal application, and transferring the produced 3D image to the service server; and a third step of the service server storing the 3D image received from the predetermined user terminal and posting the stored 3D image on a specific web site.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating the overall construction of a system for providing a 3D image production service according to the present invention;

FIG. 2 is a block diagram of a program that is installed in a user terminal in order to manage background screen service or web sites according to the present invention;

FIG. 3 is a detailed block diagram of a 3D viewer controller according to the present invention;

FIG. 4 is a diagram illustrating an example of a first embodiment of a 3D background screen according to the present invention;

FIG. 5 is a flowchart illustrating a second embodiment of an application installation and execution process for a beginner, which is performed to execute a ZEB™ service according to the present invention;

FIG. 6 is a flowchart illustrating a second embodiment of an application installation and execution process for an existing user, which is performed to execute the ZEB™ service according to the present invention;

FIG. 7 is a timing diagram illustrating a second embodiment of a web site management method of providing a 3D image production service according to the present invention;

FIG. 8 is a flowchart illustrating a second embodiment of the operation of a user terminal in the web site management method for providing the 3D image production service according to the present invention;

FIG. 9 is a flowchart illustrating a second embodiment of the operation of a ZEB™ service server in the web site management method for providing a 3D image production service according to the present invention;

FIG. 10 is a block diagram of a third embodiment to which the web site management method of providing 3D image production service according to the present invention is applied; and

FIG. 11 is a diagram illustrating an example of the operation of an application according to a third embodiment of the present invention.

### DESCRIPTION OF THE PREFERRED EMBODIMENTS

The present invention will now be described in detail in connection with preferred embodiments with reference to the accompanying drawings.

In a system for providing a 3D image production service according to the present invention, a user terminal must access a service server, subscribe to a service, undergo authentication, download a program for receiving a service, and install the program therein. Thereafter, the user terminal accesses the service server, constructs a desired background screen, and stores information about the constructed background screen in the DataBase (DB) server of the service server and a personal DB included in the terminal.

The present invention will be described using a web site provision service as an example. The web site provision service according to the present invention will be referred to as “ZEB™ service”. In addition, a web site provided by the web site provision service will be referred to as “ZEB”.

The ZEB™ service system for providing the entire ZEB™ service is a system that employs a Peer-to-Peer (P2P) method in which user terminals access a server for managing information through a network and share the information of other users.

Beginners can use the ZEB™ service after undergoing a necessary procedure and an on-line web browser-based application installation process using Active X.

Existing users can access the ZEB™ service by loading an application installed in computers or using a ZEB™ service console formed in a system tray after the installation of the application in the computers, when wanting to use the service again.

Furthermore, users who are connected to the ZEB™ service through the above process are included in a networking group using P2P, so that data between the users can be distributed without adding load to the server.

That is, the present invention relates to technology for providing a tool for producing 3D images to users through a network, receiving 3D images for respective users, which are produced using the tool, and posting the received 3D images on web sites for respective users, unlike the existing 2D web site provision method. The operation and construction of the present invention will be described in detail below.

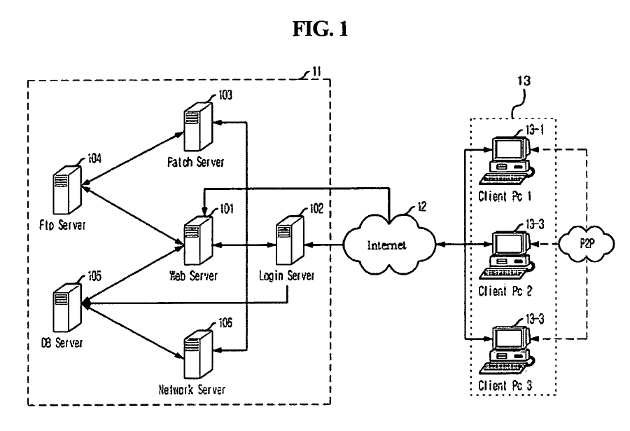

FIG. 1 is a diagram illustrating the overall construction of a system for providing a 3D image production service according to the present invention.

Referring to FIG. 1, the system for providing the 3D image production service includes a service server 11 that provides each subscriber with an individual web site, has an authentication program and a control program and provides a 3D background screen service, a plurality of user terminals 13-1, 13-2 and 13-3 that receive a background screen service and a web site service from the service server 11, and the Internet 12 that connects the service server 11 with the user terminals 13-1, 13-2 and 13-3.

The ZEB™ service server 11 includes several servers to provide subscribers with individual web sites. In more detail, the ZEB™ service server 11 includes a login server 102 (that is, an authentication server), a patch server 104 (that is, an update server) for updating a program, a web server 101 for handling a user interface related to the Web, a network server 106 for checking the access state of a user terminal, a DB server 105 for storing data, and a File Transfer Protocol (FTP) server 104 for managing files for the service.

Each of the elements will be described in more detail. The login server 102 is also referred to as an “authentication server”, and functions to process the member authentication of all user terminals that access the entire ZEB™ service. The login server 102 processes the authentication in such a way as to search for and authenticate the member information of user terminals attempting to access the entire ZEB™ service in cooperation with the DB server 105, and transfer the state values of users, who have been legitimately authenticated, to the patch server 103, the web server 101, the DB server 105 and the network server 106, so that the servers 101, 103, 104, 105 and 106 can provide a standardized service to the corresponding user terminals.

The patch server 103 is also referred to as an “update server”. The patch server 103 functions to check the latest versions of applications for the ZEB™ service of the present invention, which are installed in the user terminals whose memberships are authenticated through the login server 102, and the latest information states of data stored in the user terminals, and perform updating. If it is determined that some applications installed in the user terminals need to be updated, the patch server 103 performs an update operation on the corresponding user terminals in cooperation with the FTP server 104.

Therefore, respective user terminals that have been authenticated always undergo the version management of the applications for the ZEB™ service of the present invention through the patch server 103 before using the ZEB™ service of the present invention.

Main update operations performed by the patch server 103 include an operation of checking the application versions of user terminals, an operation of maintaining the latest versions of items stored or installed in the user terminals, an operation of reinstalling the applications of the user terminals, an operation of synchronizing the content information of the user terminals, which works in conjunction with the ZEB™ service according to the present invention, and the like.

The web server 101 is responsible for all the Web-related user terminal interfaces of the ZEB™ service of the present invention. The web server 101 provides all the data in Hyper Text Markup Language (HTML) format using a Hypertext Transfer Protocol (HTTP) method in cooperation with the DB server 105 and the network server 106 so that users can view all of the data.

The network server 106 is also referred to as a “communication server”. The network server 106 checks the real-time access states of authenticated user terminals and functions as a tool for communication between on-line users.

The representative functions of the network server 106 includes a function for checking the real-time access states of user terminals that have accessed the ZEB™ service according to the present invention, a function for enabling chatting between user terminals, a function of enabling instant messaging between user terminals, and a function of taking charge of services requiring on-line networking.

The FTP server 104 is also referred to as a “file server”, and provides content in various file forms, which must be provided to a user terminal for the performance of the ZEB™ service. The FTP server 104 is responsible for a service of providing files, such as an application execution file, an update file, an item file, etc. of the ZEB™ service, which will be provided to a user terminal.

The DB server 105 is also referred to as a “data server”, and functions to store data necessary for the performance of the ZEB™ service and provide the stored data. The DB server 105 transfers stored data and stores received data at the request of other servers, such as the web server 101 and the network server 106.

Principal data stored in the DB server 105 includes personal information about user terminals, which is used for member authentication, content information created by user terminals, and content information provided by the ZEB™ service.

The DB server 105 also stores background screen information and content information for constructing 3D background screens, and user information including information about background screens constructed by users.

The DB server 105 stores background screen information, content information and user information. The background screen information includes data and images for background themes and items that are used to construct background screens of users. The user information includes the personal information of registered members, information set by users, and information about background screens constructed by users. The content information includes objects, such as small items and skin, which will be displayed on the background screen.

Furthermore, the DB server 105 provides content, such as a bulletin board, chat data, a broadcast program, a user diary and community broadcasting, to the background screen of the user terminal through a skin mode type tool. A user can directly control various types of content on the background screen, and information about content is stored in the DB. The ZEB™ service server 11 streams or directly downloads corresponding content at the request of a user.

Furthermore, the ZEB™ service server 11 includes the authentication program and the control program, as described above. The authentication program performs authentication using user information received from the user terminal 13, and transfers authentication results to the control program. The control program reads the background screen information of a successfully authenticated user from the DB, transfers the read information to the user terminal 13, and provides program tools suitable for requested services so that the user can construct a background screen using new content. The user that uses the program tools can set an interface on the background screen.

Furthermore, the control program stores background screen information, which is set by users, in the DB. The ZEB™ service server 11 examines whether a background screen set by a user has been updated. If an update is required, the ZEB™ service server 11 searches for information to be newly transmitted, compresses the found information and transmits the compressed information to the user terminal 13.

That is, if a user accesses the ZEB™ service server 11 through the user terminal 13 and requests information about the background screen and content of the user, the ZEB™ service server 11 performs user authentication, and loads and displays corresponding information on the background screen of the user terminal 13 if the authentication is successful.

If the user requests background screens constructed by other users, the ZEB™ service server 11 retrieves information about the background screens of the corresponding users, and provides the information to the user terminal 13 so that the user can connect to other users.

The provision of background screen information, constructed by some other user, to the user terminal 13 is performed in such a way that, if the user inputs some desired user's ID information, the service server 11 searches the DB using the desired user's ID information and transmits found information about the background screen configuration of the desired user to the user terminal 13.

A 3D background screen engine capable of displaying 3D graphic and performing communication is installed on the Windows background screen of the user terminal 13.

When the user boots the user terminal 13, the 3D background screen engine installed in the user terminal 13 maintains an on-line state by transmitting authentication information to the service server and logging in to the service server. When the user terminal 13 is not connected to the service server, the 3D background screen engine performs its original background screen function and displays a previously loaded 3D graphic background screen.

If the user sets links for 3D images indicated on the background screen through the user terminal for special purposes, the service server 11 links the 3D images to DB information or some other content service in compliance with a corresponding command.

A user can always receive a program from the service server 11 through the user terminal and causes desired information and service to be displayed on the background screen. The user terminal 13 can periodically receive information from the service server 11 as long as the user terminal 13 is connected to the Internet.

The update of the background screen of the user terminal 13 can be performed by transmitting updated information from the service server to the user terminal 13.

That is, in FIG. 1, the service server 11 can provide other users with a background screen constructed by each user, and can store information about the background screen constructed by each user, in a storage space assigned to the user.

When a user terminal 13 accesses the service server 11, the service server 11 authenticates the user of the user terminal 13. If the authentication is successful, the service server 11 reads information about the background screen of the user from the DB and provides the information to the user terminal 13.

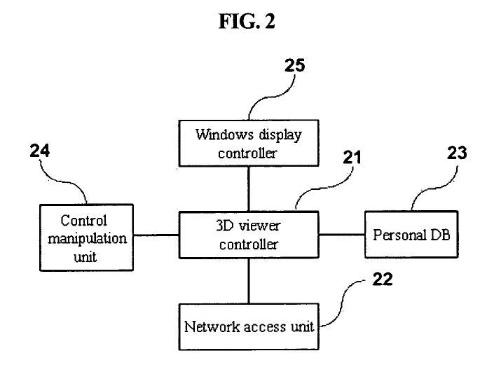

FIG. 2 is a block diagram of a program that is installed in the user terminal in order to manage background screen service or web sites according to the present invention.

A program installed in the user terminal 13 performs a function of executing a rendered 3D image on a background screen.

If a specific event is generated on the background screen by a user, a 3D background screen providing program can show the enlarged or reduced image of a portion being currently displayed, and provide scene viewing at a different angle while adjusting the view point.

The 3D viewer controller 21 operates in conjunction with a Windows display controller 25 so as to display a 3D image, which is transmitted from the service server 11 and then stored in a personal DB 23, on the background screen.

Furthermore, the 3D viewer controller 21 reads content information stored in the personal DB 23, and enables the content information to be displayed on the background screen. The 3D viewer controller 21 also performs control so that streaming data, which is received from the service server 11 through a network access unit 22, can be displayed on the background screen.

If a user needs an image or information about the background screen of some other user, the 3D viewer controller 21 first searches information stored in the personal DB 23. If desired information does not exist in the personal DB 23, the 3D viewer controller 21 requests the information from the service server 11.

If information must be updated, the 3D viewer controller 21 synchronizes information stored in the service server with information stored in the personal DB 23 at predetermined intervals.

The network access unit 22 causes the user's terminal to always connect to the server. For this purpose, the network access unit 22 performs automatic login using information stored in the personal DB when the terminal is booted.

The personal DB 23 receives information about a user, information about content and information about a background screen from the service server, and stores it.

The control manipulation unit 24 controls a 3D image, which includes the magnification, reduction and viewpoint movement of the 3D background screen.

The control manipulation unit 24 displays the on/off status of a specific input device on the background screen so as to transfer a command set by a user, and transmits a manipulation command to the 3D viewer controller 21.

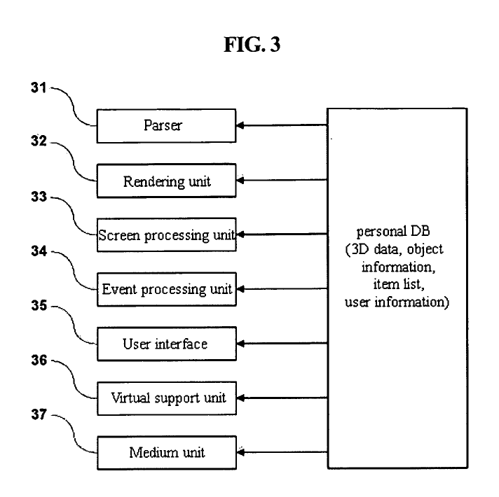

FIG. 3 is a detailed block diagram of the 3D viewer controller according to the present invention.

The 3D viewer controller 21 includes a parser 31 for parsing 3D data stored in the personal DB, a rendering unit 32 for rendering the 3D data analyzed by the parser 31, a screen processor 33 for processing variation in the screen according to navigation on a 3D background screen, an event processing unit 34 for processing a user event generated in the 3D screen, a user interface 35 for providing functions such as the magnification, reduction, rotation and movement of a view point in navigation, a virtual support unit 36 for supporting specific functions on the 3D screen, and a medium unit 37 for conducting processing so that a scene graph actually processed can be displayed within the screen.

The user interface 35 provides an interface function of performing control so that a user can produce a web site using a 3D background screen or a 3D image. The interface function includes a movement function of processing a collision generated while a specific object is moving on the 3D screen, a rotation function of allowing the user to view an object from various angles when the user wants to view the object in detail, a viewpoint control function of allowing a user to view an object from upper, lower, right and left angles at a current location, and an automatic movement function of automatically causing an object to approach a specific point.

The virtual support unit 36 performs the information viewing of objects located within a web site using a 3D background screen or a 3D image. Furthermore, the virtual support unit 36 performs a function of processing contents, which are included in a corresponding object, within a web site using a 3D background screen or a 3D image, or requesting necessary data from the server.

The parser 31 parses 3D data using a 3D data list stored in the personal DB and constructs a scene graph. The rendering unit 32 renders the scene graph, which is parsed and constructed by the parser 31, and provides the rendered scene graph to the medium unit 37. The medium unit 37 displays the rendered data on the background screen.

If a user generates a specific event in a web site using a 3D background screen or a 3D image, the generated event is processed by the event processing unit 34. In the case where the event is a simple scene update, the screen processor 33 re-constructs a scene graph for representing 3 dimensions. The re-constructed scene graph is rendered by the rendering unit 32 and is then displayed on a background screen or a web site desired by the user.

If a user requests information about a specific object in a web site using a 3D background screen or a 3D image, the virtual support unit 36 communicates with the service server through the network access unit, and stores information about an object, which is received from the service server, in the personal DB.

The virtual support unit 36 selects information about the object, which is stored in the personal DB, and provides the information using an information window other than an actual background screen and a web site.

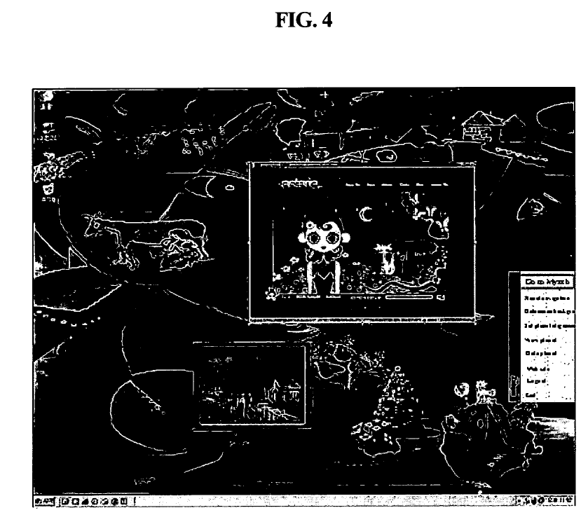

FIG. 4 is a diagram illustrating an example of the 3D background screen according to the present invention.

As shown in FIG. 4, the 3D viewer controller according to the present invention provides an information window for showing information about an object on the 3D background screen, a login window for managing user login, an Avatar window for showing a character, a session management window, a chatting window for providing chatting with other users, which enter the background screen, a background screen management window for managing registered background screens or items, and a bulletin board window and a guest book window on which other users can leave messages in a web site on the Web.

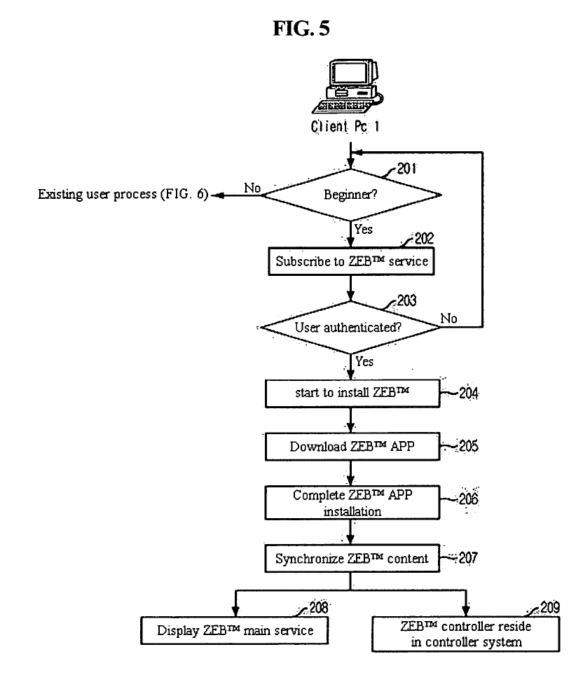

FIG. 5 is a flowchart illustrating a second embodiment of an application installation and execution process for a beginner, which is performed to execute the ZEB™ service according to the present invention.

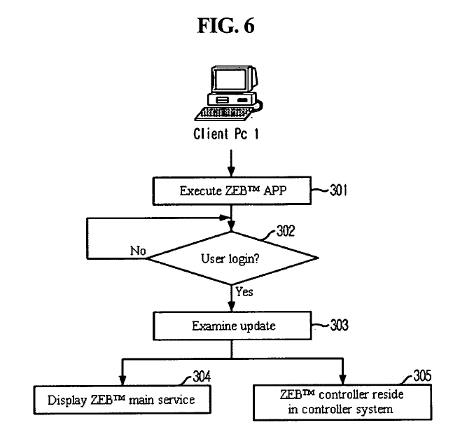

Referring to FIG. 5, a beginner accesses a web site that provides the ZEB™ service through an Internet browser on-line. Whether the user is a beginner is determined at S201. If, as a result of the determination, the user determined not to be a beginner, the process switches to the service providing process for an existing user. This will be described in detail with reference to FIG. 6. Meanwhile, if, as a result of the determination, the user is determined to be a beginner, the user subscribes to the ZEB™ service so as to receive the ZEB™ service at S202. The member information of the user, which is input for member subscription, is stored in the DB server 105 through the web server 101.

Thereafter, a user who normally has performed a member subscription process and a process of inputting member information to the DB server 105 inputs an ID and a password for the ZEB™ service. The input ID and the password are compared with member information, which has been stored in the DB server 105, through the login server 102. The login server 102 decides whether to grant a corresponding user access to the ZEB™ service based on comparison results at S203.

The user authenticated through the login server 102 proceeds to an installation start step at S204. A ZEB™ application is downloaded through a ZEB™ application installation process using Active X between the patch server 103 and the user computer based on information about the user at S205.

Since the latest information about the ZEB™ application is installed at the time of initial installation and corresponding data is provided to the beginner, the patch server 103 simply checks only the version of the installed application and the integrity of data when the beginner accesses the patch server 103 by executing the installed ZEB™ application.

If the installation of the ZEB™ application is completed through the above process at S206, content information for the ZEB™ service is synchronized at S207.

Thereafter, the user computer displays the main service window of the ZEB™ service at S208 and, at the same time, causes the ZEB™ controller to reside in the system tray of the user computer at S209.

When the entire installation process is completed as described above and the ZEB™ service is installed in the user's computer, information about the user is managed through the network server 106. A tool for communication with other users can be received through the network server 106. Furthermore, the on-line access state with respect to other users is also managed through the network server 106 and events occurring between users can be processed.

FIG. 6 is a flowchart illustrating a second embodiment of an application installation and execution process for an existing user, which is performed to execute the ZEB™ service according to the present invention.

Referring to FIG. 6, the existing user executes the ZEB™ service by executing the ZEB™ application installed in his computer or loading the ZEB™ controller residing in the system tray of his computer at S301.

Thereafter, the executed ZEB™ service application requests the user to specify an account through which the user can access the ZEB™ service. Accordingly, the user transmits an ID and a password, and the login server 102 performs a member authentication process using the transmitted information, together with the member information stored in the DB server 105 at S302.

Thereafter, the user who has been authenticated as a member undergoes version management of the ZEB™ application, which was installed in his computer, through the patch server 103, and receives added or updated items and files at S303.

Thereafter, the user's computer displays the main service window of the ZEB™ service at S304 and, at the same, time causes the ZEB™ controller to reside in the user computer system tray at S305.

When the entire installation process is completed as described above and the ZEB™ service is installed in the user's computer, information about the user is managed through the network server 106. A tool for communication with other users can be received through the network server 106. Furthermore, the on-line access state with respect to other users is also managed through the network server 106 and events occurring between users can be processed.

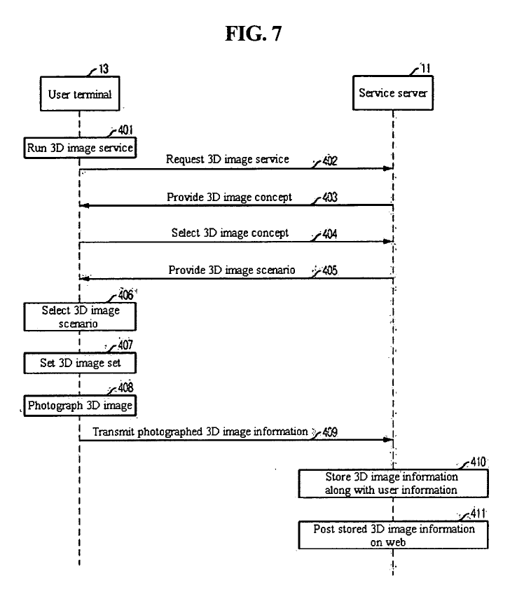

FIG. 7 is a timing diagram illustrating a second embodiment of a web site management method of providing 3D image production service according to the present invention.

In FIG. 7, there is shown a web site management method for providing the 3D image production service according to the present invention between the user terminal 13 and the ZEB™ service server 11 for providing the service according to the present invention.

The ZEB™ service server 11 includes all of the web server 101, the login server 102, the patch server 103, the FTP server 104, the DB server 105 and the network server 106, as described above. The web server 101, the login server 102, the patch server 103, the FTP server 104, the DB server 105 and the network server 106 are implemented chiefly in the form of a single entity. Accordingly, describing the method with respective servers being considered one entity, rather than describing the method with respective servers being considered respective entities, will help understand the present invention. Therefore, the operation of the predetermined user terminal 13 and the ZEB™ service server 11 will be mainly described.

It is first assumed that the predetermined user terminal 13 and other user terminals for other P2P connections have subscribed to the ZEB™ service. It is also assumed that the ZEB™ application for the present invention has been stably installed in all of the user terminals.

The user accesses the ZEB™ service and causes the main service window for the ZEB™ service to be displayed in the same manner as described with reference to FIGS. 5 and 6.

Thereafter, the user terminal 13 drives a 3D image service through the main service window at S401, and then requests the 3D image service to the ZEB™ service server 11 at S402.

Thereafter, the ZEB™ service server 11 provides a corresponding user terminal 13 with 3D image concept information for determining the concept of a 3D image at S403 so that the user terminal 13 sets a direction along which the 3D image will be produced.

The process of providing the 3D image concept at S403 is a process of determining the overall concept of a 3D image that will be produced by the user terminal 13. The ZEB™ service server 11 provides various types of concepts so that the user terminal 13 can easily define the range for producing the 3D image. The 3D image concept is a kind of layout template.

The user terminal 13 selects a concept to be used from among the provided types of concepts and transfers the selected concept to the ZEB™ service server 11 at S404.

| | | | |
|---|---|---|---|
| Daily | Indoor | Room | Room made of logs/Cute pink room |
| life | | Living room | Room made of logs and living room |
| | | | having fireplace/Ceiling having |
| | | | chandelier |
| | | Store | Convenience store/Coffee shop |
| | Outdoor | Street | Street of metropolitan area |
| | | | (buildings/roadway/walkway)/ |
| | | | Residential lane |
| | | Village | Apartment village/Residential |
| | | | street/Leisurely country village |
| | | Garden | Garden with wooden bed/Well made |
| | | | garden/Court with flowerbed |
| Travel | Indoor | Moving | Train/Bus/Boat |
| | | means | |
| | Outdoor | Beach | Beach with white sand/Beach |
| | | | beside cliff/Port |
| | | Forest | Road between trees/Surrounding |
| | | | trees and central empty lot |
| | | Field | Mostly ground and sparsely |
| | | | grass/Lawn hill/Blooming hill |

| | | |
|---|---|---|
| Media | Movie | Gone With The Wind (on the hill/ |
| | | ballroom)/Sheri (space with aquarium) |
| | Drama | Hourglass (prison or warehouse)/Paris' |
| | | lover (luxury house and pink pig) |
| | Music | To Mother by GOD (Chinese restaurant)/How |
| | video | To Chew by Mr. Yukwaehan (in bus) |
| | Comedy | Lee Mario (stage)/Balsam school (classroom) |

As the 3D image concept is selected, the ZEB™ service server 11 provides a list of scenarios, which become the axes in stories in the 3D image concept selected by the user terminal 13 at S405.

The provided 3D image scenarios are exemplified by material for stories in which various 3D animations provided by the ZEB™ service are combined. Alternatively, it is also possible for the user terminal to write the 3D image scenario.

The user terminal 13 then selects a desired 3D image scenario from among the provided scenarios at S406.

Thereafter, the user terminal 13 that has selected the 3D image scenario can perform rearrangement or decoration using the background and 3D image scenario, which are selected according to the 3D image concept, and various items (built-in items/company advertising items/user-produced items) and effects, which are provided by the ZEB™ service. This is referred to as “3D image set setting” at S407. Tools for manipulating, arranging and processing items or inserting effects are provided through the ZEB™ service application.

After the 3D image set is set according to the intention of the user of the user terminal 13, the 3D image is photographed at S408.

The user terminal 13 processes all of the portions, which have been decorated and set, into an image. A variety of functions and user interfaces for facilitating the production of an image in 3D space that has been decorated by the user terminal 13 are provided through the ZEB™ service application in the ZEB™ service. The user terminal 13 can obtain various images by utilizing the functions and the user interfaces.

The photographing tools include a crane camera tool for giving the effect of a crane camera, a circular rail and straight rail tool for giving the effect of a camera operation using the rail, and a movement trans tool for moving a rail and controlling the height of a rail. The photographing tools also include a tool for supporting zooming in and zooming out of the camera.

The photographing tools are tools for enabling a user to acquire a visual field at a desired location.

Meanwhile, in the present embodiment, a tool for helping other users to employ the moving picture more interestingly in the case where other users use produced images is provided.

Tools for helping other users to view moving images, which are supported by the present embodiment, include an outlook tower, a balloon device, and a monorail.

In more detail, the outlook tower and the balloon device are tools for enabling a user to view an image from a high place. The monorail is a tool for enabling a user to view a photographed image while riding on a monorail and looking around the set at a high place.

Thereafter, the photographed 3D image information is transferred to the ZEB™ service server 11 at S409. In the transmitted 3D image information, the internal attributes of the 3D image concept, the 3D image scenario and the 3D image set, which are selected and set by the user terminal 13, and the 3D image, which is photographed by the user terminal 13, are all generated in the form of a single file.

The ZEB™ service server 11 then stores the received 3D image information in the DB server 105 operated by the ZEB™ service server 11 along with the user information at 410.

Thereafter, the ZEB™ service server 11 posts the stored image information on a web site for the ZEB™ service of a corresponding user terminal 13, so that the image information is posted through the Web at S411.

The posted 3D image is shared within an access authority range (open/open to specific group/closed), which is specified by the user terminal 13, through the web site, so that other users can view the produced image. Therefore, a community of users can be formed based on these images. The sharing of image information between the user terminals is performed according to the P2P method.

Furthermore, a user can store scenes of the 3D image in an additional storage space, like still images, and post the stored image on other user terminals.

In sharing image information using the P2P method, transactions using cyber money, etc. is possible. In this case, although the method is P2P, the transactions are performed through an authentication and payment process using the service server.

That is, when a user A who visits a web site requests a user B to sell a 3D image in the case where the user B produces the 3D image and posts the produced 3D image on his web site, the service server can perform user authentication and then make payment of a price so that a corresponding transaction can be completed. Therefore, the user B can make profits through the sale of the 3D image and will further concentrate on the service according to the present invention. Meanwhile, the user A can easily obtain desired images. The service server can make profits through a fee based on the payment.

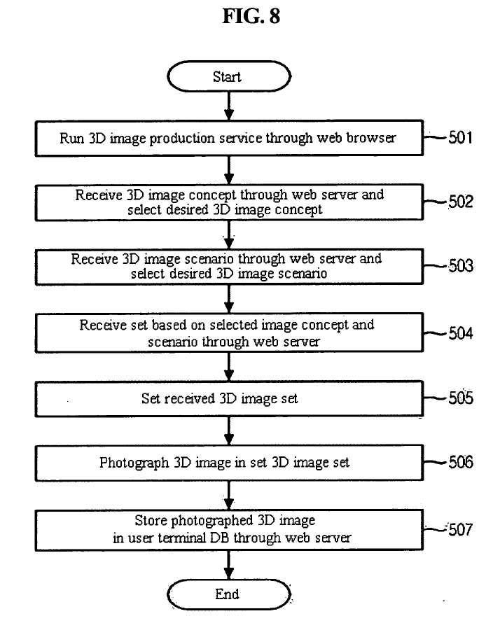

FIG. 8 is a flowchart illustrating a second embodiment of the operation of the user terminal in the web site management method for providing the 3D video production service according to the present invention.

Referring to FIG. 8, the user terminal that wants to produce a 3D image drives the 3D image service through a web browser at S501. The web browser is exemplified by the main window of the ZEB™ service application.

Thereafter, as the 3D image service is driven, the user terminal receives 3D image concepts from the ZEB™ service server 11 through the web server 101 and selects a desired 3D image concept from among the received 3D concepts at S502.

The ZEB™ service server 11 that has received a selection result from the user terminal then transfers 3D image scenarios to the user terminal through the web server 101, and the user terminal selects a desired scenario from among the received 3D image scenarios at S503.

Thereafter, the ZEB™ service server 11 that has received a selection result from the user terminal transfers a 3D image set to the user terminal through the web server 101, and the user terminal receives the 3D image set at S504 and sets the 3D image set by changing items and effects at S505.

The user terminal then photographs a 3D image in the set 3D image set using one of various methods at S506. The various methods are the same as those described in conjunction with FIG. 7.

The user terminal then transfers the photographed 3D image to the ZEB™ service server 11, so that the 3D image is stored in the DB server 105 for each user terminal through the web server 101 at S507.

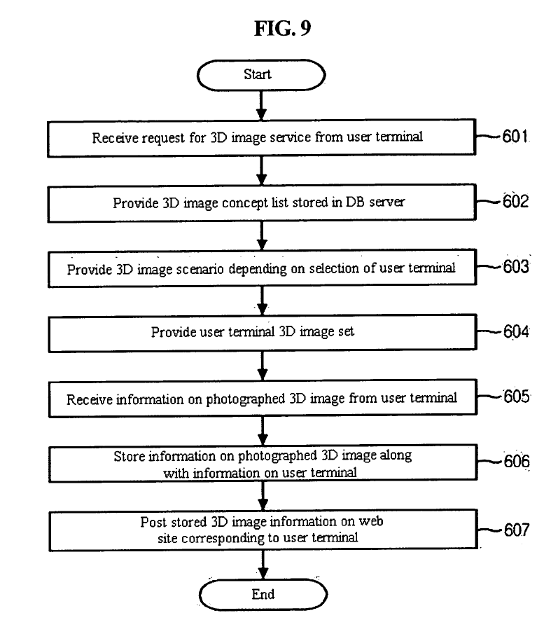

FIG. 9 is a flowchart illustrating a second embodiment of the operation of the ZEB™ service server in the web site management method for providing the 3D image production service according to the present invention.

Referring to FIG. 9, when the ZEB™ service server 11 receives a request for a 3D image service from a user terminal through the network at S601, the ZEB™ service server transmits a 3D image concept list stored in the DB server 105 to the user terminal at S602.

As the user terminal selects a desired 3D image concept from the 3D image concept list, the ZEB™ service server provides the user terminal with a 3D image scenario based on the selection of the user terminal at S603.

When the ZEB™ service server receives information about the selection of a desired 3D image scenario from the user terminal, the ZEB™ service server provides the user terminal with a 3D image set for the selected 3D image scenario at S604.

The ZEB™ service server then receives information about a 3D image photographed by the user terminal at S605.

The ZEB™ service server then stores the information about the photographed 3D image in the DB server 105, along with information about the user terminal at S606.

Thereafter, the ZEB™ service server posts the stored information about the 3D image on the Web, so that the information can be posted on a web site corresponding to the user terminal at S607.

In the ZEB™ service described above, a variety of 3D image content can be served based on the 3D image player of the ZEB™ service server 11 installed in the user terminals.

The content can be mainly classified into three types.

Education content can be provided. In particular, content such as yoga, health and dance, which can be viewed and learned by the user, is provided. The content can support a multi-angle view and magnification and reduction functions using advantages of the 3D image service according to the present invention.

Furthermore, advertising content can be provided. Companies, or organizations, products or brands that want to be advertised are 3D modeled by the ZEB™ service and then distributed to many people as advertising items. Companies or advertisers can obtain advertising effect of corresponding products or commodities.

Furthermore, amusement content can be provided. Extendibility in which games or other amusement content can also be serviced through additional functions of an application installed in each user terminal can be achieved.

The system and method for providing a 3D image production service according to the present invention, as described above, produce a 3D image through the cooperative operation of the user terminal and the service server. However, the production of a 3D image through the cooperative operation of the user terminal and the service server may place limitations on the production of a desired image of a user terminal. In consideration of the above problem, a third embodiment of the present invention proposes a scheme in which the role of the service server in producing the image is reduced and a desired image can be produced according to the user's intention.

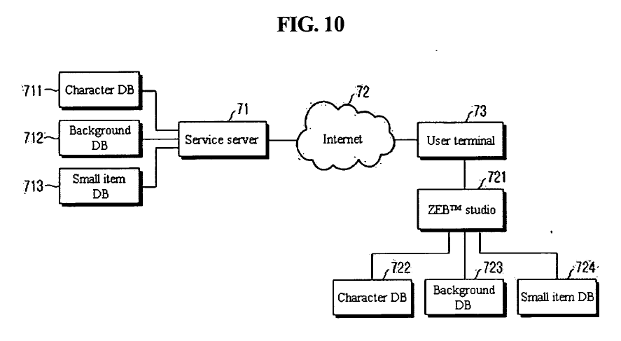

FIG. 10 is a block diagram of a third embodiment to which the web site management method for providing the 3D video production service according to the present invention is applied.

As shown in FIG. 10, a system according to the third embodiment of the present invention includes a service server 71 for providing respective subscribers with individual web sites and an application for 3D image production, a user terminal 73 for receiving a web site service from the service server 71, producing 3D images using the application provided by the service server 71 and providing the produced 3D images to the service server 71, and an Internet 72, that is, a network, for connecting the service server 71 and the user terminal 73.

The service server 71 provides the user terminal 73 with an application 721, rather than a 3D image concept, a 3D image scenario and a 3D image set, thus completing the operation concerned with 3D image production.

The user terminal 73 that has received the application 721 (for example, ZEB™ studio) runs the application 721 and produces a 3D image. Unlike the aforementioned embodiment, the user terminal 73 does not produce a 3D image using information received from the service server 71, but independently produces a 3D image using only information provided through the application 721.

The application 721 includes a character DB 722 for storing information about characters to be used for images, a background DB 723 for storing information about the backgrounds of images, and a small item DB 724 for storing information about small items used in images.

Each of the DBs 722, 723 and 724 is organized on a part basis. Therefore, a user terminal can easily construct the characters, backgrounds, small items or the like of a desired image by replacing parts even if the user terminal does not have 3D image knowledge.

The application 721 according to the present invention is provided such that general terminal users who are unskilled with 3D image production tools can easily use the application. That is, if a character is taken as an example, the character DB 722 provides personality using parts based on the general shape of a human. The term “parts” allows the intention of the user of the user terminal to be reflected by replacing respective characteristics, like parts. For example, a complete character can be formed by selecting a part regarding the eye such as a large eye, a small eye or an angry eye, a part regarding the nose, a part regarding the shape of the mouth, and a part regarding the form of a body (that is, fat, muscular, slim, etc.) and arranging them in the structure of a human (for example, a man).

The present invention allows the produced 3D image to be transmitted to the service server 71 and posted on a web site. The 3D image is difficult to transmit to the service server 71 due to its volume. Therefore, in the present invention, the service server 71 includes DBs 711, 712 and 713 corresponding to the DBs 722, 723 and 724 provided by the application 721. If the user terminal 73 transmits only attribute information about the 3D image, the service server 71 receives the attribute information from the user terminal 73, collects information based on the attribute information from the DBs 711, 712 and 713 according to the attribute information, and provides a 3D image using the information.

The attribute information includes DB information about characters extracted from the character DB 722 to produce a 3D image, information about motion of a corresponding character, position information, DB information about a specific background of the background DB 723, and DB information about a specific small item of the small item DB 724, and information about the location of the small items.

That is, the service server 71 can easily construct a 3D image without using all of the data about a 3D image, but only using information indicating that a character #7 of the character DB 722 is moved from coordinates 100, 150 on a background #8 of the background DB 723 to coordinates 120, 200.

The 3D image is posted on a web site for the ZEB™ service of a corresponding user terminal 73 by the service server 71, thus being posted through the Web.

The posted 3D image is shared within an access authority range (open/open to specific group/closed) that is specified by the user terminal 73 through the web site, so that other users can access the produced image. Therefore, a community of users can be formed based on these images. The sharing of image information between the user terminals is performed according to the P2P method.

Furthermore, a user can store scenes of the 3D image in an additional storage space while viewing them, like still images, and posts the stored images on other user terminals.

In sharing image information using the P2P method, a transaction using cyber money, etc. is possible. In this case, although the method is P2P, the transaction is performed through an authentication and payment process using the service server.

That is, when a user A who visits a web site requests a user B to sell a 3D image in the case where the user B produces the 3D image and posts the produced 3D image on his web site, the service server can perform user authentication and then make payment of a price so that a corresponding transaction can be completed. Therefore, the user B can make profits through the sale of the 3D image and will further concentrate on the service according to the present invention. Meanwhile, the user A can easily obtain desired images. The service server can make profits through a fee based on the payment.

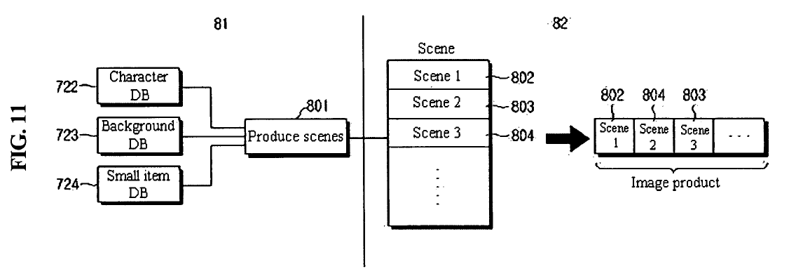

FIG. 11 is a view illustrating an example of the operation of an application according to a third embodiment of the present invention.

The third embodiment of the web site management method of providing the 3D image production service according to the present invention allows a 3D image to be produced through the application (for example, the ZEB™ studio) 721.

A process of producing 3D images using the application 721 will be described with reference to FIG. 11.

The process of producing 3D images using the application 721 can be mainly classified into two processes; a scene production process 81 and an image production process through editing 82, as shown in FIG. 11.

The scene production process 81 will be first described. Component parts for a 3D image are received through the character DB 722, the background DB 723 and the small item DB 724. The component parts are arranged and are then photographed by a virtual camera, thereby producing a scene at S801. The term “scene” refers to a scene that is photographed on a piece of background data, in the present invention.

Thereafter, in the image production process 82, respective scenes 802, 803 and 804 are stored in the DB, and a 3D image product is then completed through an editing process of combining the respective scenes into one image product.

In general, unlike functions regarding scene production, the application 721 according to the present invention provides an editing function of adding or deleting a number of produced scenes on a time basis. Therefore, not an image product, which is composed of a single scene, but a 3D image product, into which a number of scenes is combined, can be produced.

The method of the present invention described above can be implemented using a program. The program can be stored in a computer-readable recording medium (CD ROM, RAM, a floppy disk, a hard disk, a magnetic optical disk, etc.).

In accordance with the present invention described above, there are advantages in that the user terminal can provide a 3D background screen and necessary information can be immediately received through a provided 3D background screen.

Furthermore, the present invention is advantageous in that web site users can produce 3D images reflecting their tastes and post the produced 3D images on web sites.

Furthermore, the present invention is advantageous in that web site providers can cause users to post 3D images in a standardized format on their web sites.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A system for providing a 3D image production service, comprising:
a first DataBase (DB) for storing information for constructing 3D background screens, web site content information for producing 3D images, and personal information, information about a 3D background screen constructed by a user and web site information using a 3D image, the personal information, the information about a background screen and the web side information being assigned a storage space on a user basis;
a user terminal for maintaining an on-line state through login upon booting, displaying a 3D background screen after parsing and rendering 3D data stored in a second DB thereof, and setting a web site using a 3D image; and
a service server for authenticating a user while maintaining an on-line state with the user terminal, providing the user terminal with relevant tools when the user requests a configuration for managing a web site using the 3D background screen and the 3D image, storing the configuration for managing the web site using the 3D background screen and the 3D image, which is constructed by the user, in a corresponding user storage space of the first DB, and synchronizing information stored in the user terminal with information stored in the first DB through communication with the user terminal.

2. The system as set forth in claim 1, wherein the user terminal comprises:
a network access unit for maintaining an on-line state with the service server and performing communication with the service server;
the second DB for storing the 3D data, object information, item object information and user information received from the service server;
a control manipulation unit for interfacing with the user; and
a 3D viewer controller for displaying the 3D background screen through cooperative operation with the Windows display controller after parsing and rendering the 3D data stored in the second DB, requesting information from the service server through the network access unit at the request of a user, and displaying the received information on the 3D background screen or a specific window of a web site.

3. The system as set forth in claim 2, wherein the 3D viewer controller includes:
a parser for constructing a scene graph by parsing the 3D data stored in the second DB;
a rendering unit for rendering the scene graph constructed by the parser;
a medium unit for displays the web site using the 3D background screen or the 3D image, which is rendered by the rendering unit, through cooperative operation with the Windows display controller on a screen;
a user interface for providing an interface with a user;
an event processing unit for processing an event input through a user interface;
a screen processor for reconstructs the scene graph for representing the web site employing the 3D background screen or the 3D image and providing the re-constructed scene graph to the rendering unit if the event processed by the event processing unit is a scene event; and
a virtual support unit for reading information from the second DB and displaying the read information about the 3D background screen if a user requests information viewing of an object through the user interface, and displaying information about a specific window of the 3D background screen if necessary data are requested and received from the service server.

4. The system as set forth in claim 3, wherein the service server compresses updated information about the user and transmits the updated information to the user terminal, if information about the user, which is stored in the first DB, is updated.

5. The system as set forth in claim 3, wherein the service server and the user terminal synchronize the information stored in the first DB with the information stored in the second DB.

6. A method of providing a 3D image production service, comprising the steps of:
a first step of a service server, which manages a web site that provides a 3D background screen and a 3D image, providing a user terminal application for producing an 3D image to a predetermined user terminal, a specific background screen or specific web site of which are managed by the service server, and causing the user terminal to install the user terminal application;
a second step of the user terminal producing a 3D image using a 3D image concept, a 3D image scenario and a 3D image set, which are provided through the user terminal application, and transferring the produced 3D image to the service server; and
a third step of the service server storing the 3D image received from the predetermined user terminal and posting the stored 3D image on a specific web site.

7. The method as set forth in claim 6, wherein the user terminal application is provided to the predetermined user terminal authenticated by the service server, and comprises a tool for photographing the 3D image and a tool for constructing the 3D image set.

8. The method as set forth in claim 6, wherein the 3D image concept is a layout template, and is a background provided for a range for producing the 3D image in order to determine an overall concept of the 3D image to be produced by the predetermined user terminal.

9. The method as set forth in claim 6, wherein the 3D image scenario is provided by the service server according to the 3D image concept, and provides material for a story in which a plurality of 3D animations is combined.

10. The method as set forth in claim 6, wherein the 3D image set is constructed according to the 3D image concept and the 3D image scenario, and is re-constructed according to an intention of the user of the user terminal using items and effects provided through the user terminal application.

11. The method as set forth in claim 6, wherein the produced 3D image can be transferred between user terminals, which belong to the service server, through a specific web site in a Peer-to-Peer (P2P) method.

12. The method as set forth in claim 6, wherein, in order to transmit the 3D image produced at the second step, internal attributes of the 3D image concept, the 3D image scenario and the 3D image set, which are selected and set by the predetermined user terminal, and the 3D image, which is photographed by the predetermined user terminal, are generated in single file form, and are then transmitted to the service server.

13. A method of providing a 3D image production service, comprising:
a first step of a user terminal, which subscribes to the 3D image production service and has a user terminal application for a 3D image service, running the user terminal application;
a second step of the user terminal receiving 3D image concepts from a 3D image service server and selecting a desired 3D image concept from among the received 3D image concepts, as the user terminal application is run;
a third step of the user terminal receiving 3D image scenarios from the 3D image service server that has received the selected 3D image concept, and selecting a desired scenario from among the received 3D image scenarios;
a fourth step of the user terminal receiving a 3D image set from the 3D image service server that has received the selected 3D image scenario, and setting the 3D image set; and
a fifth step of the user terminal photographing a 3D image in the set 3D image set and transmitting the photographed 3D image to the 3D image service server so that the photographed 3D image is posted on a web site.

14. The method as set forth in claim 13, wherein the user terminal application is provided to a user terminal authenticated by the service server, and comprises a tool for photographing the 3D image and a tool for constructing the 3D image set.

15. The method as set forth in claim 13, wherein the 3D image concept is a layout template, and is a background provided for a range for producing the 3D image in order to determine an overall concept of the 3D image to be produced by the predetermined user terminal.

16. The method as set forth in claim 13, wherein the 3D image scenario is provided by the service server according to the 3D image concept, and provides material for a story in which a plurality of 3D animations is combined.

17. The method as set forth in claim 13, wherein the 3D image set is constructed according to the 3D image concept and the 3D image scenario, and is re-constructed according to an intention of a user of the user terminal using items and effects provided through the user terminal application.

18. The method as set forth in claim 13, wherein the produced 3D image can be transferred between user terminals, which belong to the service server, through a specific web site in a P2P method.

19. The method as set forth in claim 13, wherein, in order to transmit the 3D image produced at the fifth step, internal attributes of the 3D image concept, the 3D image scenario and the 3D image set, which are selected and set by the predetermined user terminal, and the 3D image, which is photographed by the predetermined user terminal, are generated in single file form and are then transmitted to the service server.

20. A method of providing a 3D image production service, comprising:
a first step of a service server, which provides a user terminal with a user terminal application for a 3D image service and provides the 3D image service to the user terminal, detecting running of the user terminal application of the predetermined user terminal and providing 3D image concepts to the predetermined user terminal;
a second step of the service server receiving information about selection of a 3D image concept from among the provided 3D image concepts and providing 3D image scenarios based on a selection result;
a third step of the service server receiving information about selection of a 3D image scenario from among the provided 3D image scenarios and transmitting a 3D image set based on a selection result; and
a fourth step of the service server receiving a 3D image, which is photographed in the 3D image set by the predetermined user terminal, and posting the 3D image on a web site of the user terminal.

21. The method as set forth in claim 20, wherein the user terminal application is provided to a predetermined user terminal authenticated by the service server, and comprises a tool for photographing the 3D image and a tool for constructing the 3D image set.

22. The method as set forth in claim 20, wherein the 3D image concept is a layout template, and is a background provided for a range for producing the 3D image in order to determine an overall concept of the 3D image to be produced by the predetermined user terminal.

23. The method as set forth in claim 20, wherein the 3D image scenario is provided by the service server according to the 3D image concept, and provides material for a story in which a plurality of 3D animations is combined.

24. The method as set forth in claim 20, wherein the 3D image set is constructed according to the 3D image concept and the 3D image scenario, and is re-constructed according to an intention of a user of the user terminal using items and effects provided through the user terminal application.

25. The method as set forth in claim 20, wherein the produced 3D image can be transferred between user terminals, which belong to the service server, through the specific web site in a P2P method.

26. The method as set forth in claim 20, wherein, to transmit the 3D image produced at the fourth step, internal attributes of the 3D image concept, the 3D image scenario and the 3D image set, which are selected and set by the predetermined user terminal, and the 3D image, which is photographed by the user terminal, are generated in single file form and are then transmitted to the service server.

27. A method of providing a 3D image production service, comprising:
a first step of a service server, which manages a web site, providing a user terminal application for producing a 3D image to a user terminal, a specific web site of which is managed, through the service server;
a second step of the user terminal producing a 3D image using DBs regarding characters, backgrounds and small items, which are provided through the user terminal application, and transferring the produced 3D image to the service server; and
a third step of the service server storing the 3D image received from the predetermined user terminal and posting the stored 3D image on a specific web site.

28. The method as set forth in claim 27, wherein the user terminal application is provided to a predetermined user terminal authenticated by the service server, and comprises a tool for photographing the 3D image and a tool for constructing the 3D image set.

29. The method as set forth in claim 27, wherein the DBs regarding characters, backgrounds and small items, which are provided through the user terminal application, comprise a character DB for storing information about characters to be used in the 3D image, a background DB for storing information about backgrounds of the 3D image, and a small item DB for storing information about small items used in the 3D image.

30. The method as set forth in claim 29, wherein each of the DBs provides corresponding information on a part basis.

31. The method as set forth in claim 27, wherein the produced 3D image can be transferred between user terminals, which belong to the service server, through the specific web site in a P2P method.

32. The method as set forth in claim 27, wherein, to transmit the 3D image produced at the second step, internal attributes of the 3D image are generated in single file form and are then transmitted to the service server.

33. The method as set forth in claim 29, wherein the user terminal application produces the 3D image by producing scenes around each background of the background DB and editing the scenes.
